(19) United States
(12) Patent Application Publication
(10) Pub. No.: US 2017/0253297 A1
(43) Pub. Date: Sep. 7, 2017

(54) FRONT TRACK SYSTEM

(71) Applicant: Steven James Christini, Philadelphia, PA (US)

(72) Inventor: Steven James Christini, Philadelphia, PA (US)

(21) Appl. No.: 15/452,046

(22) Filed: Mar. 7, 2017

Related U.S. Application Data
(60) Provisional application No. 62/304,579, filed on Mar. 7, 2016.

(51) Int. Cl. B62M 27/02; B62D 55/06; B62D 55/04

(52) U.S. Cl. CPC B62M 27/02; B62D 55/04; B62D 55/06; B62M 2027/021; B62M 2027/022; B62M 2027/023; B62M 2027/025; B62M 2027/027

(57) ABSTRACT

A front driven track system for a two-wheeled vehicle is provided. The front driven track system is used in conjunction with a two-wheeled vehicle through rotatably mounting a front track system to the front position of the two-wheeled vehicle, running between the front forks thereof, and linked to the front drive system via a front drive track hub. A front split ski system may also be adjustably connected to the axle clamps of the front fork, whereby a distance that a lower portion of the front track system protrudes through the split ski system is selectively adjustable. The front drive track hub, on which the front track system runs, is enabled to transfer either braking power from the front brake and/or traction from power system powering the two-wheeled vehicle.

### CROSS-REFERENCE TO RELATED APPLICATION

This application claims the benefit of priority of U.S. provisional application No. 62/304,579, filed 7 Mar. 2016, the contents of which are herein incorporated by reference.

### BACKGROUND OF THE INVENTION

The present invention relates to all wheel drive motorcycles or all-wheel drive 2-wheeled ATV for use in sand, dirt, and snow and, more particularly, to an apparatus, method and system for converting the front driven wheel of the 2-wheel all drive vehicle to a track or paddle wheeled system to increase traction, control, and transfer of power.

Motorcycles/two-wheeled utility vehicle/two-wheeled ATVs are generally driven by the rear wheel, but can also be driven by both wheels. Current snow bike systems have a rear track system to convert a standard motorcycle into a snow or sand capable machine with a rear snowmobile type track system. The track system is positioned on the rear of the vehicle and only powered in the rear. This rear track system is prone to getting stuck in deep snow, sand, or mud when used in less than ideal conditions.

The lack of a front driven track system positioned between the front forks under-utilizes the contact areas where the machine touches the surface, causing less than optimal traction. The absence of a front track system also eliminates the ability to use the system as a brake.

Currently, there is no compact front track system that is positioned between the front forks of a motorcycles/two-wheeled utility vehicle to drive a front track system or that can be used as a front brake system, or that has the capacity to have high speed operation similar to a snowmobile.

As can be seen, there is a need for a front braking and traction track system through installing a front track system between the front forks of a two-wheeled vehicle. By linking the front drive system with the two-wheeled vehicle, additional power can be delivered efficiently from the engine for providing increased traction and/or braking power. The front track system could be installed and assembled with a front split ski with the ability to raise and lower to assist in floatation and/or braking

### SUMMARY OF THE INVENTION

In one aspect of the present invention, a front drive track system for a two-wheeled vehicle having a front fork includes a front track system rotatably connected along an axle between axle clamps of the front fork, wherein the front track system is attached to and adapted to turn with a steering mechanism of the front fork; and a front split ski system having two spaced apart ski portions disposed downwardly of said axle, wherein a lower portion of the front track system protrudes between the two spaced apart ski portions.

In another aspect of the present invention, the front drive track system for a two-wheeled vehicle having a front fork includes a front track system rotatably connected along an axle between axle clamps of the front fork, wherein the front track system is attached to and adapted to turn with a steering mechanism of the front fork; a front split ski system having two spaced apart ski portions disposed downwardly of said axle, wherein a lower portion of the front track system protrudes between the two spaced apart ski portions; a ski height adjuster configured to raise and lower the split ski system relative to the lower portion of the front track system; at least one front drive track hub between axle clamps of the front fork and coupled to the front track system; a front disc brake integrated into the front track system for stopping the front track system via the front drive track hub; and a mechanical or hydraulic front drive system powering the front track system, wherein the mechanical or hydraulic front drive system is also powered from a motor of the two-wheeled vehicle also powering a rear wheel thereof.

In yet another aspect of the present invention, the front track system can be replaced with a sand paddle wheel utilizing the same front adjustable height ski, brakes, and other claims of the invention.

In yet another aspect of the present invention, the front track system is powered with an electric front motor independently of the rear drive system.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of an outer casing of the present invention;

FIG. 2 is a top right detail perspective view of an exemplary embodiment of the present invention;

FIG. 3 is a top left detail perspective view of an exemplary embodiment of an inner grabber of the present invention;

FIG. 4 is a bottom right detail perspective view of an exemplary embodiment of the present invention;

FIG. 5 is a section view of an exemplary embodiment of the present invention, taken along line 5-5 in FIG. 1; and

FIG. 6 is a section view of an exemplary embodiment of the present invention, with paddle wheel as a substitution to the track system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a front driven track system used in conjunction with a standard motorcycle through rotatably mounting a front track system to the front position of the motorcycle, running between the front forks, and linked to the front drive system via a front drive track hub. A front split ski system may also be adjustably connected to the axle clamps of the front fork, whereby a distance that a lower portion of the front track system protrudes through the split ski system is selectively adjustable. The front drive track hub, on which the front track system runs, is enabled to transfer either braking power from the front brake and/or traction from power system powering the motorcycle.

It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figure.

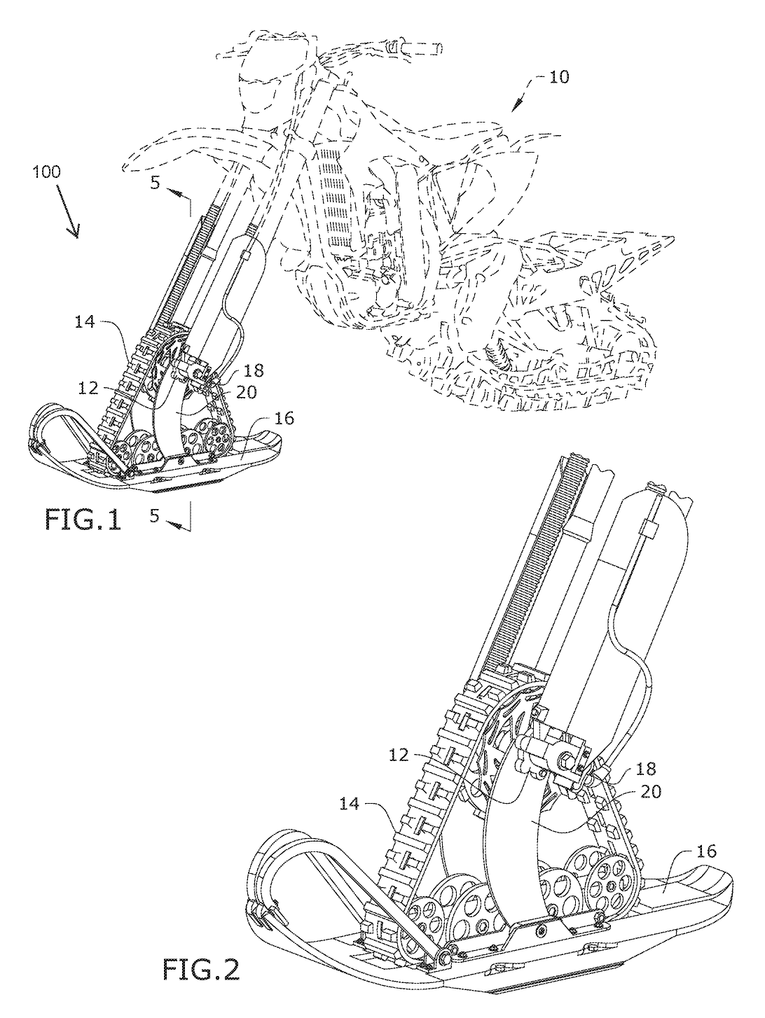

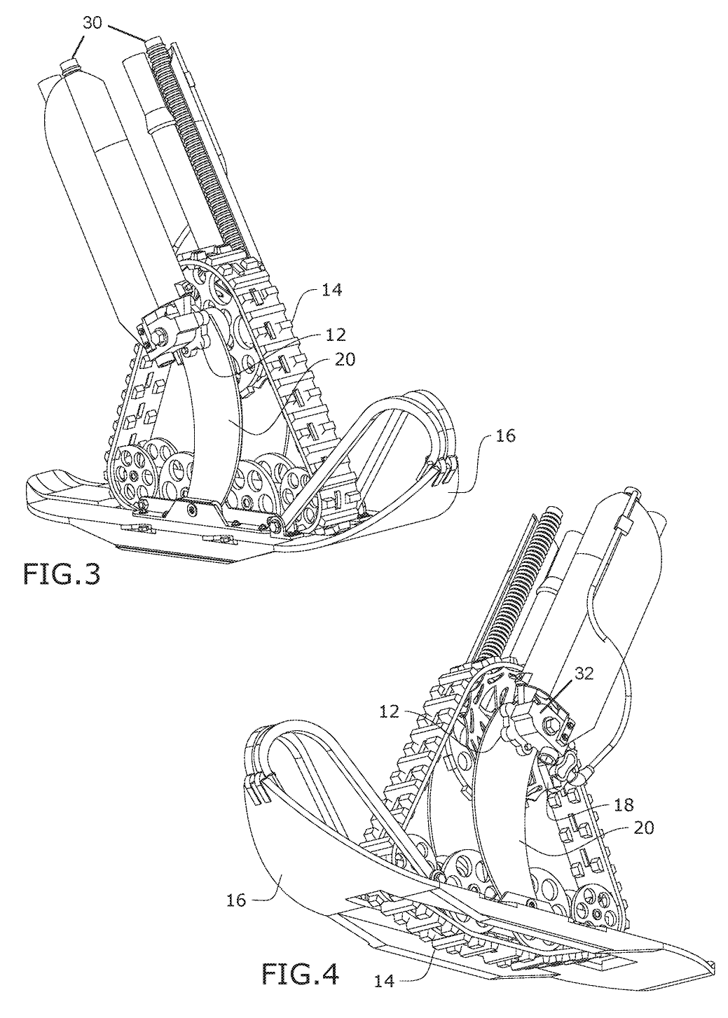

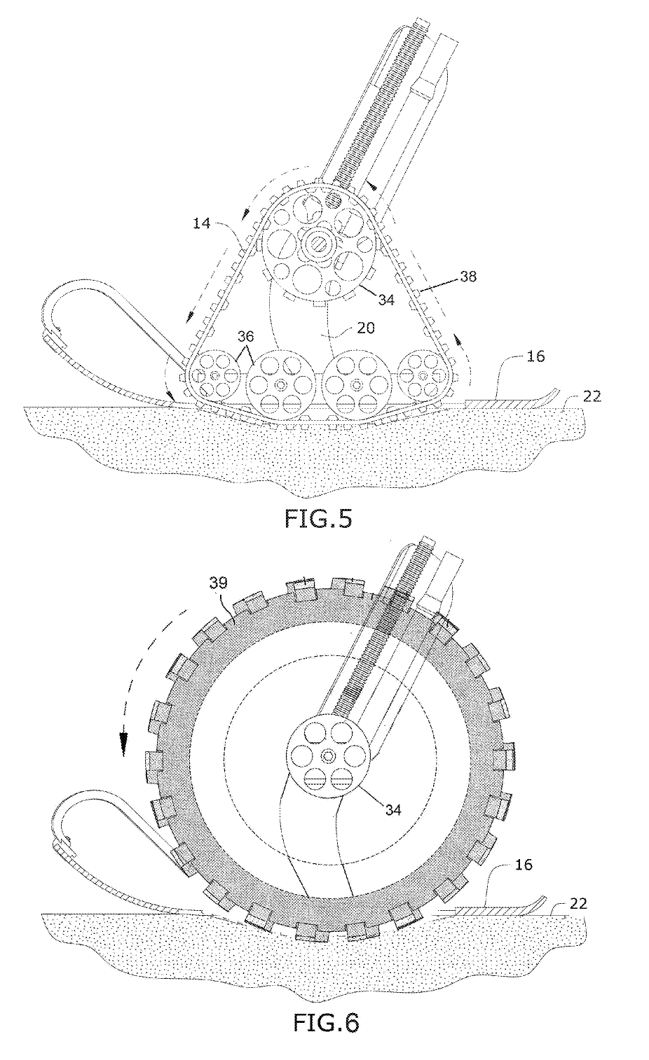

Referring to FIGS. 1 through 5, the present invention may include a front track system positioned in the front of a 2WD/AWD motorcycle or vehicle, between the front fork, where the track can operate as either a braking system or a driving system or a combination of both. The front track system can be implemented with or without a front split ski that surrounds the track system thus giving the track the ability to have better flotation on snow sand, or soft surfaces.

The present invention can either be a “freewheel” as a floating member and be utilized as a braking system, be powered from the standard rear driven track or wheeled system, or be a combination of both.

The front track system will be pushed from the rear of the machine in the case of a brake only system. The braking force will be applied to the rotating member by a disc brake or equivalent braking device.

The present invention may be powered from the rear of the vehicle through its drive system or other suitable drive system. The front track system may be attached to the front fork or swing arms of the motorcycle/vehicle (in the case of a tele-lever design).

The present invention may include a front driven track system 100. The front driven track system may include a front track system 14 rotatably mounted along an axle between the front forks 30 of a two-wheeled vehicle 10, such as a AWD or 2WD motorcycle or the like. In certain embodiments, a top pulley 34 of the front track system 14 may be rotatably mounted where the left and right dropouts (axle clamps) 32 couple to a front drive track hub 12 positioned between the front forks 30, as illustrated in the FIGS. The front drive track hub 12 may be attached directly to the front track system 14 for powering it. The front track system 14 may utilize lower pulleys 36 to, in conjunction with the top pulley 34, to engage a drive belt 38 to transfer motion and power from the vehicle 10 to the ground 22. The front track system 14 may be centered between the front forks 30 so as to protrude a lower portion thereof through the middle of a front split ski system 16. The front split ski system 16 may include two parallel skis spaced apart or a unitary ski with a centric void, enabling the protrusion of the front track system 14 therethrough. The front split ski system 16 can be raised and lowered around the front track system 14 via a ski height adjuster, which may be attached to the front forks 30 at the top and the front ski in the middle. The front split ski system 16 can be raised and lowered mechanically by the ski height adjuster 20, which may include, for example, a cable actuator, an electric motor system, a spring pressure system or pneumatic or hydraulic systems.

The front track system 14 may include an integrated front disc brake 18 enabling the front track system 14 to brake the vehicle 10 by stopping the front track system 14 via the front drive track hub 12. The integrated front disc brake 18 may include standard tracks, rollers, and the like.

### The Front Track System 14 and the Front Split Ski System 16

By being located between the front forks 30 the front track system 14 may be either a “freewheel” floating member utilized as a braking system, be powered from a standard rear driven track or wheeled system or a combination of both. The advantage of the freewheeling or powered front track system 14 is to provide additional traction during operation and steering of the vehicle. A limitation of the current front sled only motorcycle is the limited ability to track during normal operation and especially through turns. Additionally, the ability to raise and lower the front split ski system 14 relative to the front track system 14 is to provide additional traction and driving ability (in the event of a driven front track system 14) through deep snow, sand or other ground material 22. Presently, the front sled systems only ride through or on the top of the snow, sand or other ground material 22. Therefore, advantageously, a variable height front split ski system 16 will enable operation under a greater range of adverse riding conditions.

### Brake System Only

The front drive track hub 12 may be position on both sides of the top pulley 34 between the front forks 30 to carry the front track system 14 in a rotational manner. When the braking force is applied to the integrated front disc brake 18, the front drive track hubs 12 slow, thus transmitting the front braking force into the front track and thus into the snow 22 or ground. This force brakes and slows the vehicle 10. It also adds an additional safety benefit not found on any other snow bike or mud bike vehicle. The ski height adjuster 20, which may be attached to the front forks 30 at the top and the front ski in the middle, may be utilized to raise and lower the front split ski system 16, which in turn places the front track system 14 higher or lower in the snow 22, thereby assisting in braking or slowing of the vehicle 10.

### Front Powered System

The vehicle 10 may power the front track system 14 to the left and right driven dropouts (axle clamps) 32, which in turn power the front drive track hubs 12. The front drive track hubs 12 may be attached directly to the front track system 14 and be powered by the engine through the front of the vehicle 10, which then moves the tread in the forward direction, thus pulling the vehicle 10 forward while a rear track system (not shown) pushes the vehicle 10. This front track system 14 can also freewheel in the forward direction when the clutching mechanism in the front drive track hub 12 or axle clamps 32 disengages the front wheel drive system. The front tracking system 14 can be steered as a normal motorcycle but powered by its AWD/2WD system, for example, a Christini® AWD or Yamaha® hydraulic 2-Trac system. In certain embodiments, the front track system 14 could be replaced by a front wheel 39 for various surfaces, such as a paddle wheel for more fluid surfaces, or hard wheel for harder surfaces. All other parts are inter-dependent to brake or propel the vehicle 10.

A method of using the present invention may include the following. The front driven track system 100 disclosed above may be provided. The front driven track system 100 may be used in conjunction with a standard motorcycle with a rear track system or an AWD or 2WD motorcycle or 2-wheeled vehicle to power the front track system 14 to brake the vehicle 10 and/or propel or “pull” the vehicle 10 forward (as an assist to the rear track system which will be pushing). A user would mount the front track system 14 as disclosed above, and then drive the vehicle 10 with the agility of a competition motorcycle yet the capabilities similar to a military tank.

It should be understood, of course, that the foregoing relates to exemplary embodiments of the invention and that modifications may be made without departing from the spirit and scope of the invention as set forth in the following claims.

What is claimed is:

1. A front drive track system for a two-wheeled vehicle having a front fork, comprising:
a front track system rotatably connected along an axle between axle clamps of the front fork, wherein the front track system is attached to and adapted to turn with a steering mechanism of the front fork; and
a front split ski system having two spaced apart ski portions disposed downwardly of said axle, wherein a lower portion of the front track system protrudes between the two spaced apart ski portions.

2. The front drive track system of claim 1, further comprising a ski height adjuster configured to raise and lower the split ski system relative to the lower portion of the front track system.

3. The front drive track system of claim 1, further comprising at least one front drive track hub between axle clamps of the front fork and coupled to the front track system.

4. The front drive track system of claim 3, further comprising a front disc brake integrated into the front track system for stopping the front track system via the front drive track hub.

5. The front drive track system of claim 1, wherein the front track system is powered with a mechanical or hydraulic front drive system powered from a motor of the two-wheeled vehicle also powering a rear wheel thereof.

6. The front drive track system of claim 1, wherein the front track system is powered with an electric front motor independently of the rear drive system.

7. A front drive track system for a two-wheeled vehicle having a front fork, comprising:
a front track system rotatably connected along an axle between axle clamps of the front fork, wherein the front track system is attached to and adapted to turn with a steering mechanism of the front fork;
a front split ski system having two spaced apart ski portions disposed downwardly of said axle, wherein a lower portion of the front track system protrudes between the two spaced apart ski portions;
a ski height adjuster configured to raise and lower the split ski system relative to the lower portion of the front track system;
at least one front drive track hub between axle clamps of the front fork and coupled to the front track system;
a front disc brake integrated into the front track system for stopping the front track system via the front drive track hub; and
a mechanical or hydraulic front drive system powering the front track system, wherein the mechanical or hydraulic front drive system is also powered from a motor of the two-wheeled vehicle also powering a rear wheel thereof.
